(19) United States
(12) Patent Application Publication
(10) Pub. No.: US 2011/0272351 A1
(43) Pub. Date: Nov. 10, 2011

(54) CHLORINATOR FOR A BIOSAND FILTER

(75) Inventors: George C. Greene, III, Charleston, SC (US); Bruce M. Okkema, Zeeland, MI (US)

(73) Assignee: Water Missions International

(21) Appl. No.: 13/048,400

(22) Filed: Mar. 15, 2011

Related U.S. Application Data
(60) Provisional application No. 61/332,238, filed on May 7, 2010.

(51) Int. Cl. C02F 9/04; C02F 1/76; C02F 3/00; C02F 1/68

(52) U.S. Cl. 210/631; 210/206; 210/85; 210/198.1; 210/95

(57) ABSTRACT

A chlorinator for a biosand filter includes a chlorinator adapted for treating water after it has been filtered by a biosand filter. The chlorinator has a housing having an inlet on a side and an outlet on a bottom. The inlet is adapted to be attached to the outlet of a biosand filter. A dividing partition divides the housing into an inlet section, an outlet section and a chlorinator section. The inlet section is in fluid communication with the inlet, the chlorinator section and the outlet section. The chlorinator section is in fluid communication with the inlet section and the outlet section. The outlet section is in communication with the outlet. A flow control mechanism in the inlet section is adapted to adjust the amount of water flowing through the chlorinator section.

### CROSS-REFERENCE TO RELATED APPLICATIONS

This application claims the benefit of and priority to pending U.S. Provisional Patent Application Ser. No. 61/332,238 filed May 7, 2010.

### FIELD OF INVENTION

The instant invention is related to biosand filters, and more specifically, to a chlorinator adapted to treat water after it has been filtered by a biosand filter.

### BACKGROUND OF THE INVENTION

A biosand filter is a filter used to for contaminated water from rain, surface, or ground sources. Gravel and sand are layered inside a filter container with a collection pipe (usually PVC) situated at the base of the container (see FIG. 1). The contaminated water is poured through the top of the filter and passes through a plate that diffuses the stream and blocks large contaminants (e.g. stones, large twigs, leaves). The top few centimeters of the sand trap the bulk of micro-organisms, which accumulate and develop into a highly active food chain, most commonly called the biological layer. This biological layer traps and feeds on the micro-organisms and contaminants in the water. The filtered water collection tube, or outlet tube, is positioned at a level higher than the biological level itself, which will permanently keep the water surface level higher than the biological layer. Further filtration occurs in the lower layers of sand and gravel, which remove contaminants that cause odor, cloudiness, and taste. These sand and gravel layers along with the biological layer provide the filtration for a typical biosand filter.

BioSand Filters can be constructed of many different materials, although the most common materials are plastic or concrete barrels. While implementations exist in many different sizes and varieties, the most common design is intended for use in rural homes where naturally safe or treated water sources are not available. While several commercial and community-scale implementations exist, the largest use of biosand filters has been in the humanitarian arena to developing countries. These commercial and community-scale implementations of biosand filters are ideal point of use filters provided in or around the homes and communities in developing countries.

One thing that can be improved with household (or point of use) biosand filters is that, when optimized, the filters only remove about 80-90%, of contaminants. This means that the water taken from a biosand water filter in these developing countries still has a substantial amount of contaminant remaining in the water. However, because of the biological layer in a biosand filter, one can not treat the water inside of the biosand filter. Thus, there is a need to treat the water after it is filtered by a biosand filter.

The instant invention is designed to address the above mentioned problems.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 shows an environmental view of one embodiment of a chlorinator according to the instant invention being attached to the outlet tube of a common biosand filter.

FIG. 2 shows a perspective view of the embodiment of the chlorinator for a biosand filter shown in FIG. 1.

FIG. 3 shows another perspective view of the chlorinator for a biosand filter from FIG. 1.

FIG. 4 shows a front view of the chlorinator for a biosand filter from FIG. 1.

FIG. 5 shows a back view of the chlorinator for a biosand filter from FIG. 1.

FIG. 6 shows a top view of the chlorinator for a biosand filter shown in FIG. 1.

FIG. 7 shows a side view of the chlorinator for a biosand filter shown in FIG. 1.

FIG. 8 shows another side view of the chlorinator for a biosand filter shown in FIG. 1.

FIG. 9 shows a cross-sectional perspective view of the chlorinator for a biosand filter shown in FIG. 1

FIG. 10 shows a blown-up partially disassembled perspective view of the chlorinator for a biosand filter shown in FIG. 1.

FIG. 11 shows a back view of the chlorinator for a biosand filter from FIG. 1 with cross-sectional lines H-H, G-G, and F-F shown.

FIG. 11A shows a cross-sectional view through lines F-F of the chlorinator for a biosand filter shown in FIG. 11.

FIG. 11B shows a cross-sectional view through lines G-G of the chlorinator for a biosand filter shown in FIG. 11.

FIG. 11C shows a cross-sectional view through lines H-H of the chlorinator for a biosand filter shown in FIG. 11.

FIG. 12 shows a perspective view of the chlorinator for a biosand filter of FIG. 1 with the top removed to disclose the interior of the chlorinator with the gate at the bottom of the v-notch weir.

FIG. 13 shows a perspective view of the chlorinator for a biosand filter of FIG. 1 with the top removed to disclose the interior of the chlorinator with the gate at the top of the v-notch weir.

FIG. 13A shows a cross-sectional view through section B-B of the chlorinator for a biosand filter shown in FIG. 13 with the gate at the top of the v-notch weir.

FIG. 13B shows a cross-sectional view through section B-B of the chlorinator for a biosand filter shown in FIG. 13 with the gate at the bottom of the v-notch weir.

FIG. 13C shows a cross-sectional view through section B-B of the chlorinator for a biosand filter shown in FIG. 13 with the gate at a raised position between the top and bottom of the v-notch weir.

FIG. 13D shows a cross-sectional view through section B-B of the chlorinator for a biosand filter shown in FIG. 13 with the gate at another raised position between the top and bottom of the v-notch weir.

FIG. 14 shows a flow diagram of one embodiment of the method of treating water by a biosand filter with a chlorinator according to the instant invention.

### SUMMARY OF THE INVENTION

The instant invention is directed toward a chlorinator adapted for treating water after it has been filtered by a biosand filter. The chlorinator has a housing having an inlet on a side and an outlet on a bottom. The inlet is adapted to be attached to the outlet of a biosand filter. A dividing partition divides the housing into an inlet section, an outlet section and a chlorinator section. The inlet section is in fluid communication with the inlet, the chlorinator section and the outlet section. The chlorinator section is in fluid communication with the inlet section and the outlet section. The outlet section is in communication with the outlet. A flow control mechanism in the inlet section is adapted to adjust the amount of water flowing through the chlorinator section.

### DETAILED DESCRIPTION OF THE DRAWINGS

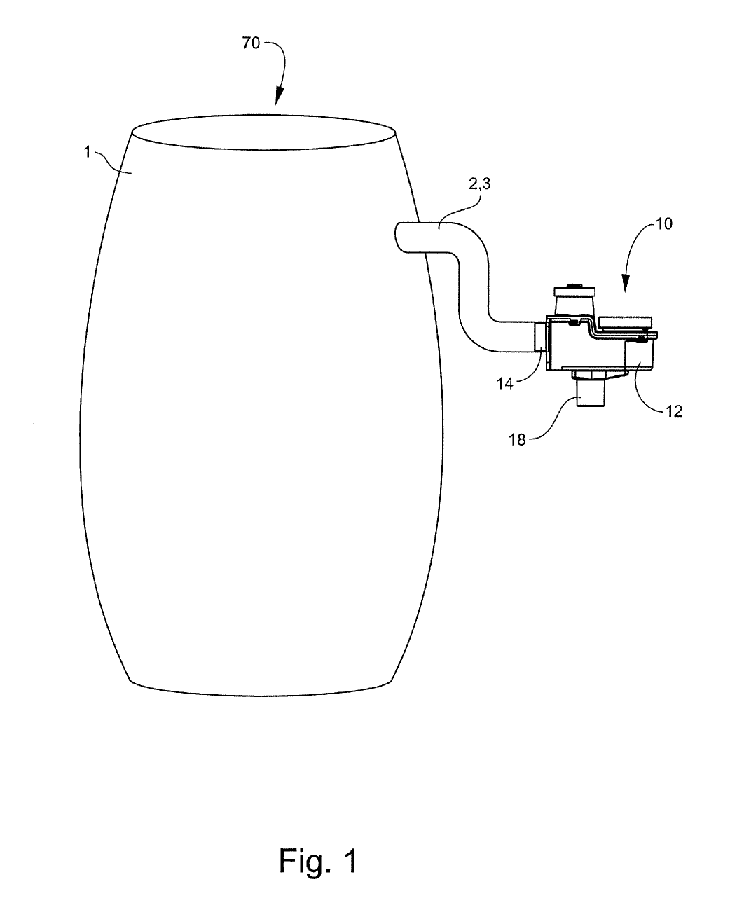

Referring to the drawings, wherein like numerals indicate like elements, there is shown in FIG. 1 an embodiment of a chlorinator 10 adapted to treat water after it has been filtered by a biosand filter 1. Chlorinator 10 is designed to attach to the outlet tube 2 of the biosand filter 1. Chlorinator 10 may be for treating the water exiting a biosand filter via chlorine. Chlorinator 10 may be adapted to attach to any size, shape, or type of biosand filter 1, including any size or shape outlet tube 2 provided with the various biosand filters. For example, chlorinator 10 may be adapted to attach to a ½ inch diameter pipe 3, as shown in FIG. 1. However, the invention is not so limited. Although the instant invention is designed to treat water after it has been treated by a biosand filter 1, chlorinator 10 may also be used in other environments requiring chemical treatment (not just chlorine) of a fluid.

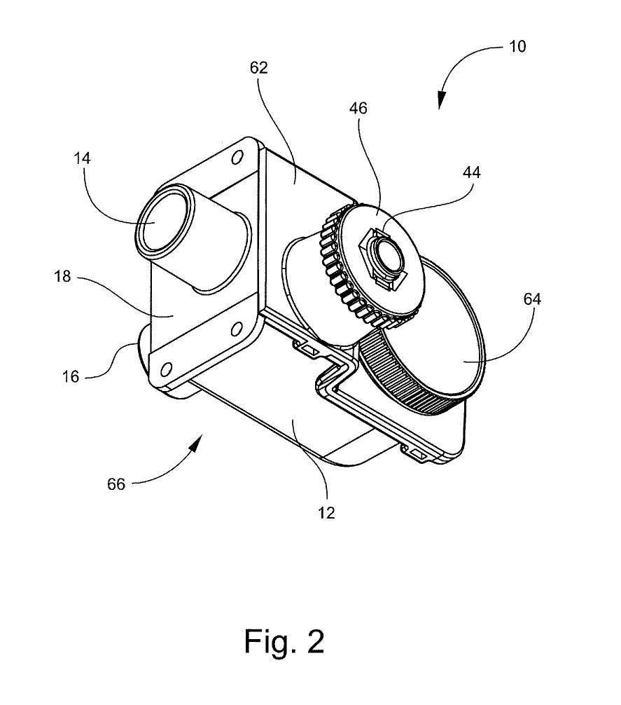

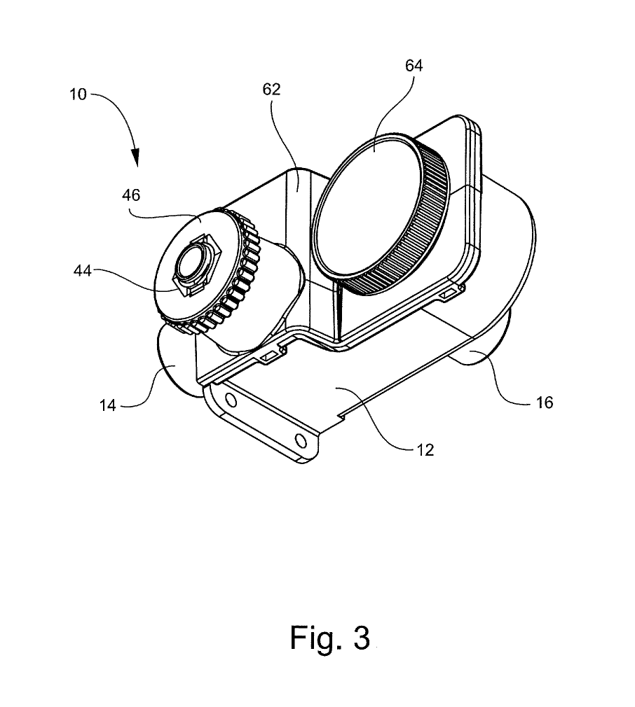

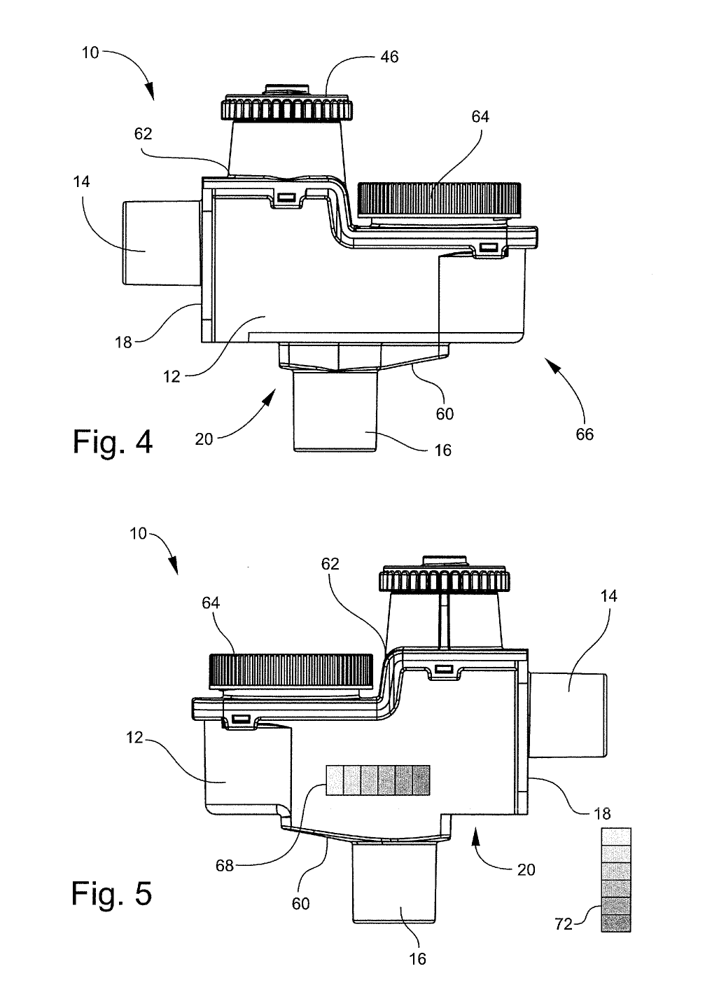

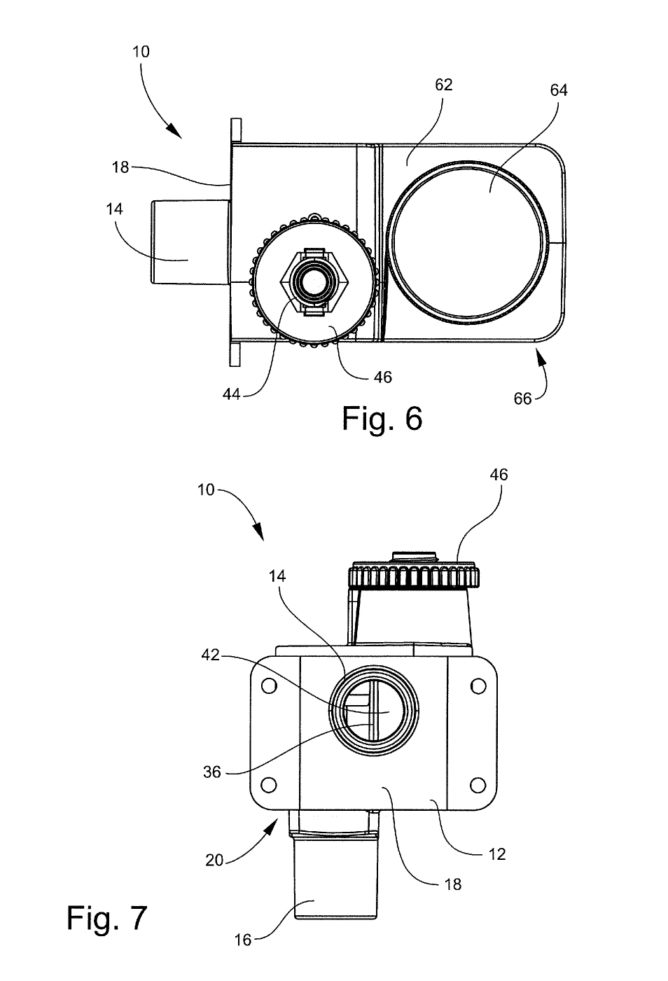

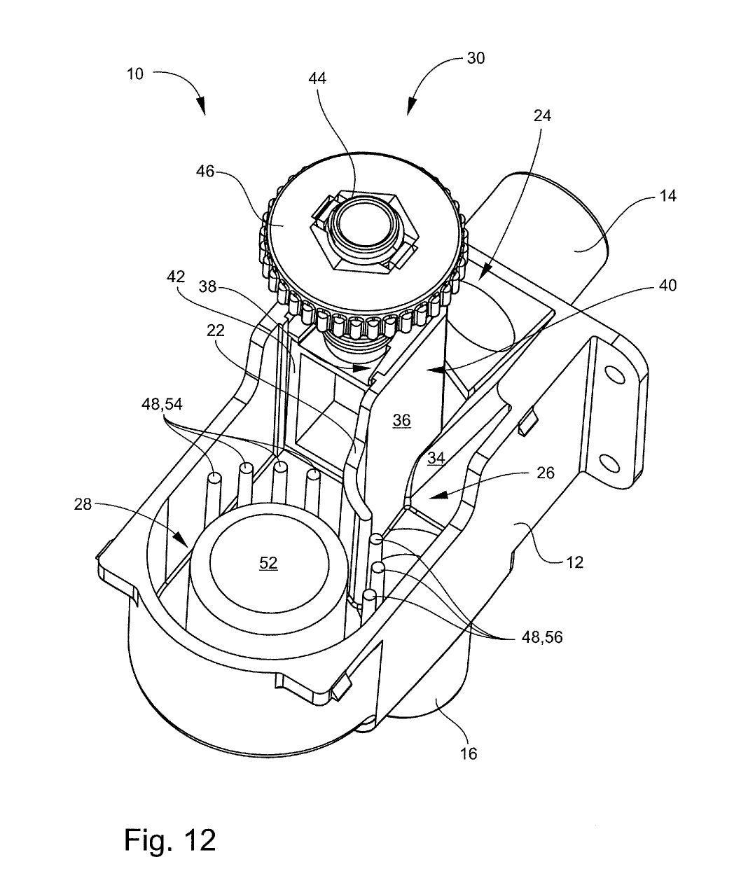

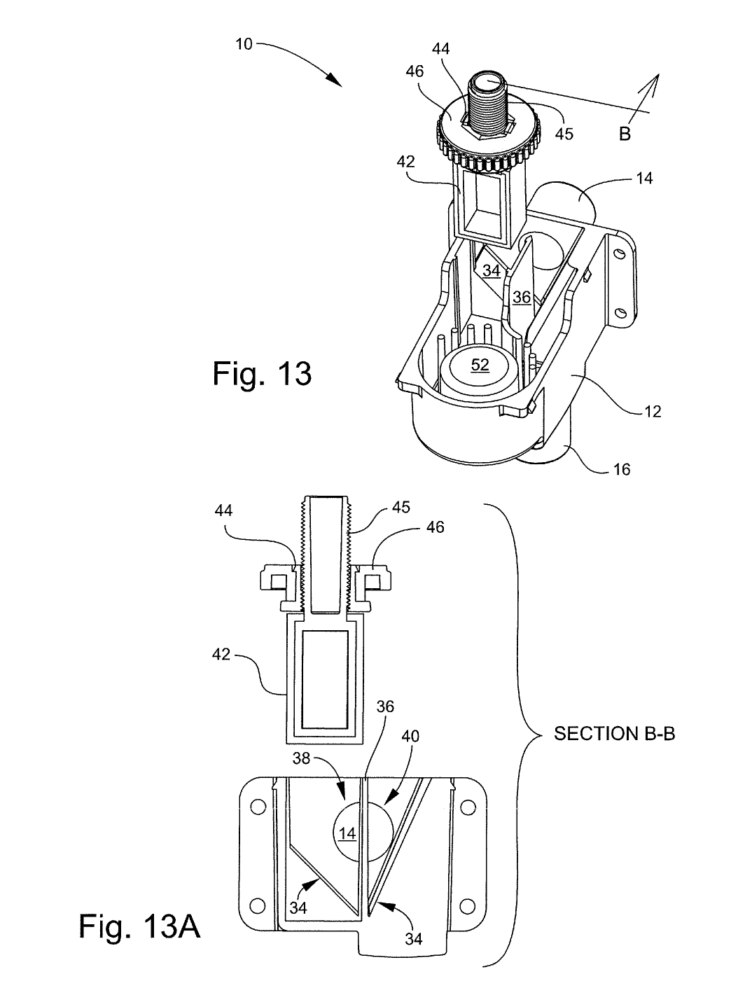

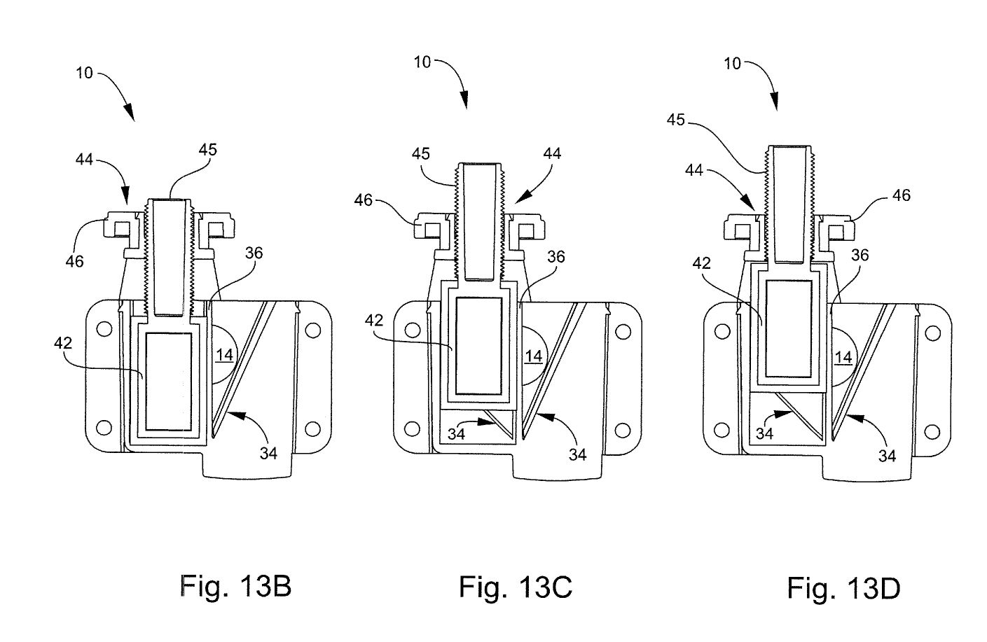

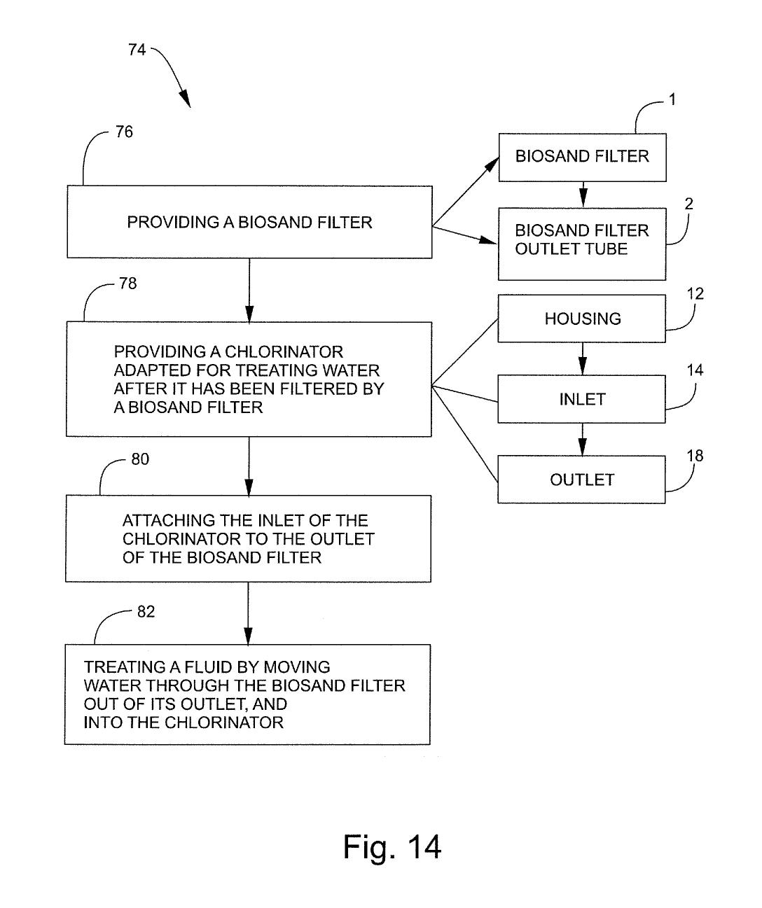

Referring to FIGS. 2-13, chlorinator 10 is shown in detail. Chlorinator 10 may generally include: a housing 12 having an inlet 14 on a side 18 and an outlet 16 on a bottom 20. These parts are described in detail below.

Housing 12 may be included with chlorinator 10. Housing 12 may be for providing a reservoir for holding fluid in chlorinator 10. Housing 12 may be any size or shaped reservoir, including, but not limited to, being a substantially rectangular shaped reservoir 66. Substantially rectangular shaped reservoir 66 may have a substantially rectangular shape with curved sides. Housing 12 may be made of any material, including, but not limited to non-corrosive materials like plastics. Housing 12 may include inlet 14 on a side 18. Although in the Figures, side 18 is shown as the left side of housing 12, side 18 may be any side of housing 18, thus, inlet 14 may be positioned on any side of housing 12. Housing 12 may also include outlet 16 positioned on the bottom 20. Outlet 16 may be positioned anywhere on the bottom 20 of housing 12.

Inlet 14 may be included in chlorinator 10. Inlet 14 may be for providing an inlet for moving fluid into the housing 12 of chlorinator 10. Inlet 14 may be any type, size or shape inlet for allowing fluid to be moved into housing 12. In one embodiment, inlet 14 may be adapted to be attached to the outlet tube 2 of a biosand filter 1. Most biosand filters have % inch diameter outlet pipes, made of PVC or galvanized steel. As such, in one embodiment, the inlet 14 of the instant chlorinator may be adapted to be attached to a ½ inch diameter pipe 3 (PVC or galvanized). However, the invention is not so limited, and in other embodiments, the inlet 14 of the chlorinator 10 may be adapted to be attached to other sized outlet tubes of biosand filters. Inlet 14 may include any type of fixing or attachment for attaching to the outlet tube 2 of biosand filter 1.

Outlet 16 may be included in chlorinator 10. Outlet 16 may be for providing an outlet for moving fluid out of the housing 12 of chlorinator 10. Outlet 16 may be any type, size or shape outlet for allowing fluid to be moved out of housing 12. In one embodiment, housing 12 may have a sloped bottom 60, where bottom 20 is sloped in all directions toward outlet 16. In this embodiment chlorinator 10 may be self draining. This feature of the instant chlorinator will prevent water from remaining in the chlorinator and eroding the chlorinator tablet.

A dividing partition 22 may be providing in chlorinator 10. Dividing partition 22 may be for dividing housing 12 into an inlet section 24, an outlet section 26 and a chlorinator section 28. Dividing partition 22 may be any device for dividing housing 12 into an inlet section 24, an outlet section 26, and a chlorinator section 28. Inlet section 24 may be a section where fluid is introduced into housing 12. Inlet section 24 may be in fluid communication with the inlet 14, the chlorinator section 28, and the outlet section 26. The chlorinator section 28 may be a section in housing 12 where a chlorine tablet (or other chemical) may be inserted for treating the fluid flowing through chlorinator section 28. The chlorinator section 28 may be in fluid communication with the inlet section 24 and the outlet section 26. Outlet section 26 may be a section 12 where fluid is removed from housing 12. The outlet section 26 may be in fluid communication with the outlet 16, and may receive water from inlet section 24, outlet section 26, or a combination thereof. This provides two flow paths through the chlorinator 10: 1) directly from the inlet 14 to the outlet 16; and 2) from the inlet 14 through the chlorinator section 28 and to the outlet 16.

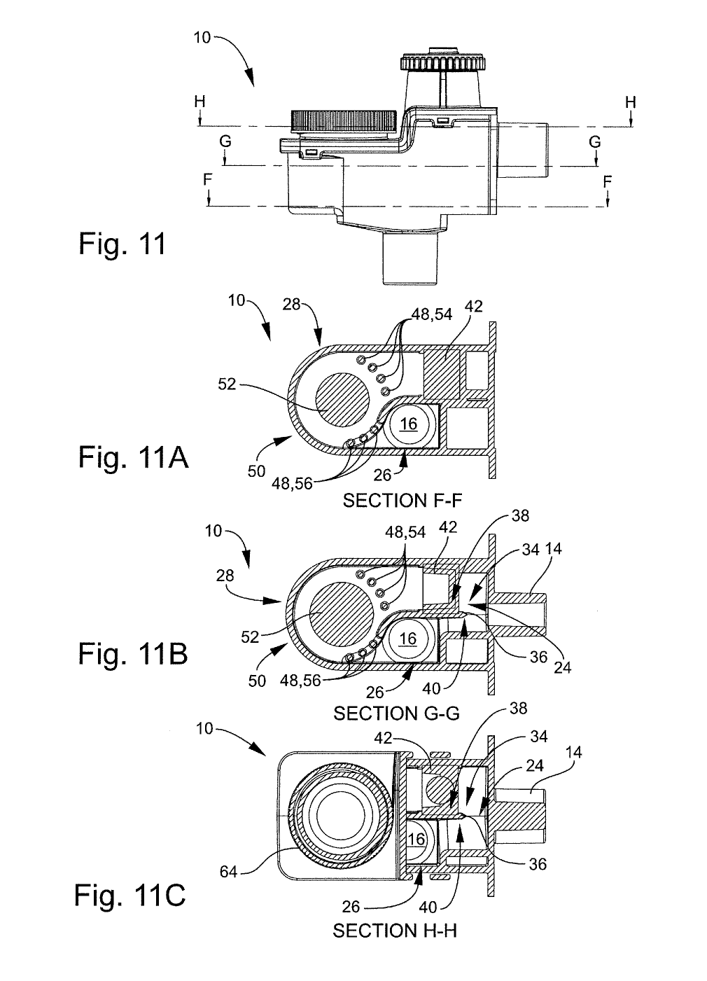

A flow control mechanism 30 may be provided with chlorinator 10. Flow control mechanism 30 may be for controlling the amount of fluid flowing through chlorinator section 28. Flow control mechanism 30 may be any type of device for controlling the amount of fluid flowing through chlorinator section 28. The flow control mechanism 30 may be positioned in the inlet section 24 where it may be adapted to adjust the amount of water flowing through chlorinator section 28 from inlet 14. In one embodiment, the flow control mechanism 30 may be adapted to adjust the amount of fluid flowing through chlorinator 10 from 0% to 100%. In another embodiment, the flow control mechanism 30 may be adapted to adjust the amount of water flowing through chlorinator 10 from 0% to 50%. When the flow control mechanism 30 is positioned at 0% fluid flowing through the chlorinator section 28, 0% of the fluid flows through the chlorinator section 28 and 100% of the fluid flows directly from the inlet section 24 to the outlet section 26 (see FIG. 11). In this position, fluid enters the inlet 14 of the housing 12, flows around the housing 12 in a counter clock-wise direction and out of the outlet 16 into the outlet section 26. When the flow control mechanism 30 is positioned at 100% fluid flowing through the chlorinator section 28, 100% of the fluid flows through the chlorinator section 28 and 0% of the fluid flows directly from inlet section 24 to outlet section 26. In this position, fluid enters inlet 14 of the housing 12, flows around the hosing in a clock-wise direction into the chlorinator section 28 and then into outlet section 26 (see FIG. 11). Finally, when the flow control mechanism 30 is positioned somewhere between 0% and 100%, some of the fluid flows through the chlorinator section 28. The percentage of flow through the chlorinator section 28 may depend on the position of flow control mechanism 30, i.e., the flow control mechanism diverts a certain percentage of the water from the inlet section 24 to the chlorinator section 28, and the remaining percentage of fluid flows from the inlet section 24 directly to the outlet section 26. Flow control mechanism 30 may be any type of device for controlling the amount of fluid flowing through chlorinator section 28, including, but not limited to, a v-notch weir 32, as shown in the Figures. However, the invention is not so limited, and any other flow control device for adjusting the amount of fluid flowing through chlorinator section 28 may be used, including, but not limited to any valves, like an L-valve.

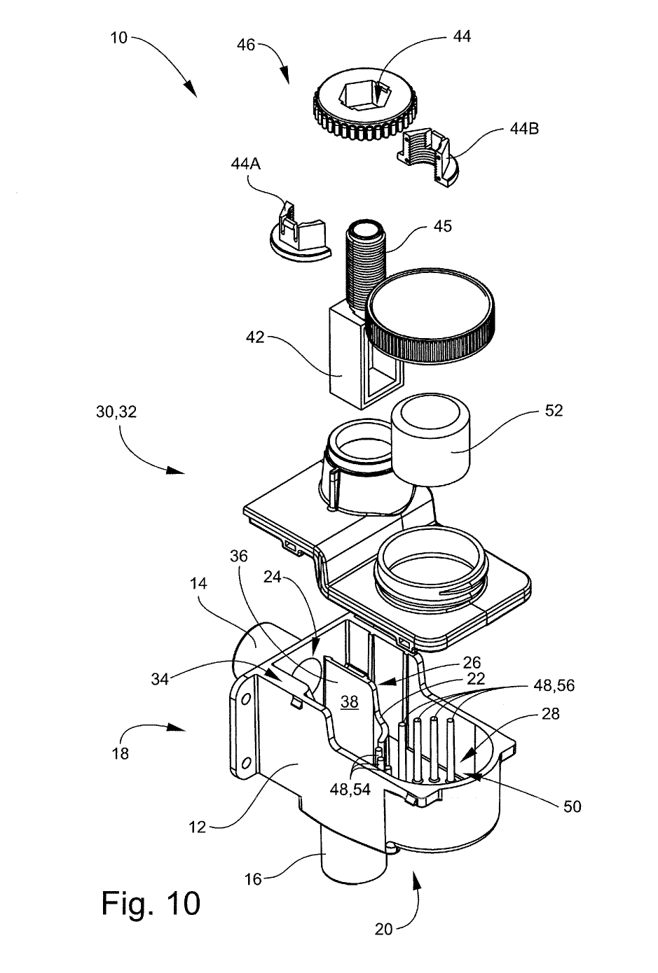

A v-notch weir 32, as shown in FIGS. 10-13, may be included in one embodiment of chlorinator 10. V-notch weir 32 may be for providing a flow control mechanism 30 adapted for controlling the amount of fluid flowing through chlorinator section 28. V-notch weir 32 may control the amount of fluid flowing through chlorinator section 28 by any amount, including, but not limited to, from 0% to 50% of fluid flowing through chlorinator section 28. V-notch weir 32 may be any known v-notch type of weir where the basic principle is that discharge is directly related to the water depth above the crotch (bottom) of the V; this distance is called head (h). V-notch weir 32 may generally include a v-notch 32, a diverter wall 36, and a gate 42. The V-notch 34 may be positioned in the inlet section 24 of housing 12. The v-notch 34 may causes small changes in discharge to have a large change in depth allowing more accurate head measurement than with a rectangular weir. The diverter wall 36 is positioned in the center of the v-notch 34. The diverter wall 36 thereby creates a chlorinator section side 38 of the v-notch 34, and an outlet section side 40 of v-notch 34. The chlorinator section side 38 is in communication with the chlorinator section 28, and the outlet section side 40 is in communication with the outlet section 26. The gate 42 may be positioned on the chlorinator section side 38 of the diverter wall 36. Gate 42 may be adapted to move vertically up and down for adjusting the amount of flow through the chlorinator section 28. The gate 42 may be any size or shape gate that allows for adjusting the amount of flow through chlorinator section 28.

In one embodiment, the gate 42 may include: a threaded rod 45 on the top of the gate 42; and an adjustment knob 46 having a threaded hole 44. In this embodiment, the threaded rod 45 may be inserted through the threaded hole 44 of the adjustment knob 46, whereby, when the adjustment knob 46 is rotated in one direction the gate 42 may move vertically upward, and when the adjustment knob 46 is rotated in the other direction, the gate may move vertically downward. In one embodiment, the threaded hole may be made of a right side 44B and a left side 44A, as shown in FIG. 10. In one embodiment, the adjustment knob 46 or the top 62 may include an indicator associated with the adjustment knob 46. The indicator may be adapted for showing the position of gate from 0% to 100% flow through the chlorinator section 28. The adjustment knob 46 associated with the flow control mechanism 30 may be positioned at the desired place for obtaining optimum results of the treated water.

A plurality of retaining pins 48 may be included in chlorinator section 28. See FIG. 10-12. The retaining pins 48 may be for retaining chlorine tablet 52 in chlorinator section 28. Retaining pins 48 may be oriented in a circle 50 adapted to retain the chlorine tablet 52 in the chlorinator section 28 In one embodiment, the retaining pins 48 may include inlet retaining pins 54, and outlet retaining pins 56. Inlet retaining pins 54 may be positioned approximate to inlet section 24. Outlet retaining pins 56 may be positioned approximate to outlet section 26. In one embodiment, the outlet retaining pins 56 may be spaced closer together than the inlet retaining pins 54. This spacing feature may allow more fluid flow onto the chlorine tablet 52, while still retaining the chlorine tablet 52. The retaining pins 56 should be designed to provide negligible impedance to the flow of water through the chlorinator section.

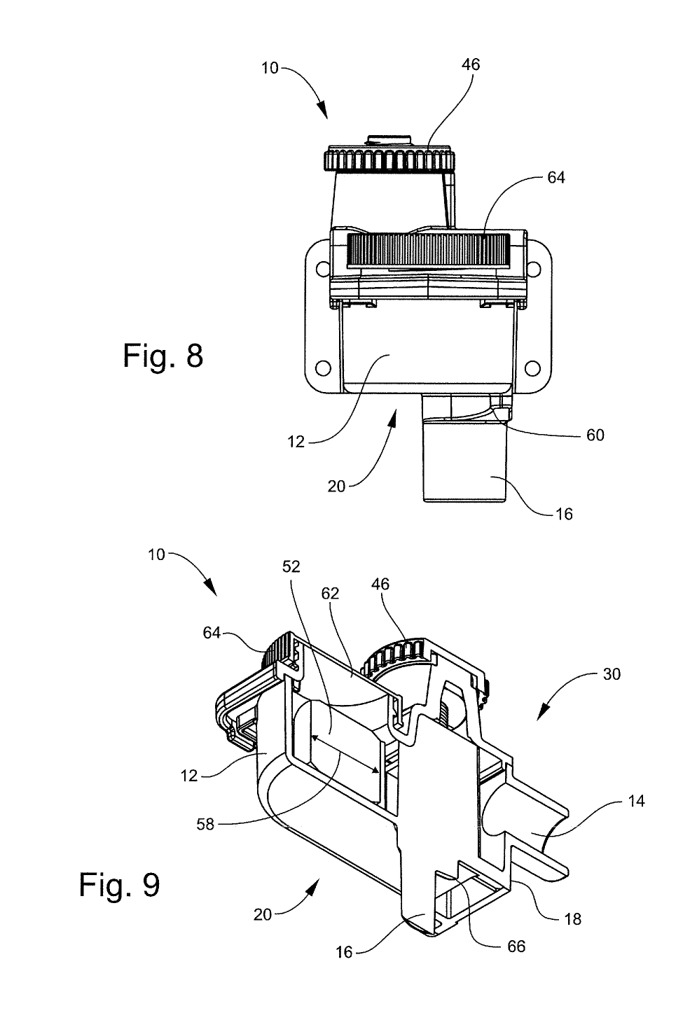

The chlorine tablet 52 may be included in chlorinator 10. Chlorine tablet 52 may be any size or shape chlorine tablet. In one embodiment, the chlorine tablet may have a diameter 58 of 1 inch. See FIG. 9. Although the instant invention is directed toward a chlorinator with a chlorine tablet, the invention is not so limited, and other chemical tablets or treatments may be used as desired.

A top 62 may be included with chlorinator 10. Top 62 may be for enclosing the top of housing 12. Top 62 may be any size or shape device for enclosing the top of housing 12. The top 62 may be sealed to the housing by a seal, and may be secured to the housing by any means, including, but not limited to, screws or tabs, as shown in the Figures. In one embodiment, the top 62 may comprise a removable cap 64. Removable cap 64 may be positioned over the chlorinator section 28 and be adapted for allowing chlorine tablets 52 to be inserted into chlorinator section 28. Removable cap 64 may be a transparent cap that allows visual inspection of the chlorine tablet 52. This feature may allow for visual inspection of the chlorine tablet 52, to let the user know when to add another chlorine tablet to the chlorinator 10. The removable cap 64 may be removable by any means, including, but not limited to, being threaded.

The chlorinator 10 of the instant invention may be adapted to treat a fluid, like water, by adding chlorine or any other chemical to the fluid. Chlorinator 10 may be designed to add any amount of chlorine or chemical to the fluid flowing through the device. In one embodiment, chlorinator 10 may be adapted for adding ½ to 5 parts per million chlorine. In another embodiment, the chlorinator 10 may be adapted for adding 1 to 2 parts per million chlorine.

A chlorine indicator chart 68 may be provided on housing 12 in one embodiment of chlorinator 10. See FIG. 5. Chlorine indicator chart 68 may be provided on the outside of the housing 12 and may be adapted for indicating the amount of chlorine present in the treated water. The chlorine indicator chart 68 may correspond to provided chlorine indicator strips 72. When available, users should test the water treated by the instant chlorinator with chlorine indicator strips 72. These chlorine indicator strips 72 will turn a certain color. The chlorine indicator chart on the outside of the housing may show the ideal colors associated with the chlorine indicator strips 72 for the amount of chlorine present in the treated water.

The instant invention also includes a kit 70 for treating water with a biosand filter and chlorinator. Kit 70 generally includes, but is not limited to: a biosand filter 1 having an outlet tube 2; and chlorinator 10, as described herein. See FIG. 1. In one embodiment, kit 70 may also include a plurality of chlorine indicator strips 72 adapted for testing the amount of chlorine present in the treated water. Chlorine indicator strips 72 may correspond to the provided chlorine indicator chart 68 on the side of housing 12.

The instant invention also includes a method 74 of treating fluid by a biosand filter 1 with a chlorinator 10. Method 74 may include any steps for treating fluid by a biosand filter 1 with a chlorinator 10. In one embodiment, method 74 may include the following steps: a step 76 of providing a biosand filter 1 with an outlet tube 2; a step 78 of providing chlorinator 10; a step 80 of attaching the inlet 14 of chlorinator 10 to the outlet tube 2 of biosand filter 1; and a step 82 of treating a fluid by moving the fluid through biosand filter 1, out of outlet tube 2, and into chlorinator 10.

Chlorinator 10, and all of its parts therein, may be made of any material. This material may include, but is not limited to, any plastics, metals, etc. In one embodiment, the chlorinator 10 and its parts may be made of non-corrosive parts like plastics.

The present invention may be embodied in other forms without departing from the spirit and the essential attributes thereof, and, accordingly, reference should be made to the appended claims, rather than to the foregoing specification, as indicated in the scope of the invention.

We claim:

1. A chlorinator adapted for treating water after it has been filtered by a biosand filter comprising:
a housing having an inlet on a side and an outlet on a bottom;
said inlet being adapted to be attached to the outlet of a biosand filter;
a dividing partition dividing said housing into an inlet section, an outlet section and a chlorinator section;
said inlet section being in fluid communication with said inlet, said chlorinator section and said outlet section;
said chlorinator section being in fluid communication with said inlet section and said outlet section;
said outlet section being in fluid communication with said outlet; and
a flow control mechanism in said inlet section adapted to adjust the amount of fluid flowing through said chlorinator section.

2. The chlorinator of claim 1 wherein said inlet being adapted to be attached to a ½ inch diameter pipe.

3. The chlorinator of claim 1 wherein said flow control mechanism being adapted to adjust the amount of water flowing through said chlorinator from 0% to 100%.

4. The chlorinator of claim 3 wherein said flow control mechanism being adapted to adjust the amount of water flowing through said chlorinator from 0% to 50%.

5. The chlorinator of claim 1 wherein said flow control mechanism including a v-notch weir.

6. The chlorinator of claim 5 wherein said v-notch weir comprising:
a v-notch positioned in said inlet section;
a diverter wall positioned in the center of said v-notch creating a chlorinator section side of said v-notch weir in communication with said chlorinator section, and an outlet section side of said v-notch weir in communication with said outlet section; and
a gate being positioned on said chlorinator section side of said diverter wall.

7. The chlorinator of claim 6 wherein said gate being adapted to move vertically up and down for adjusting the amount of flow through said chlorinator section.

8. The chlorinator of claim 7 wherein said gate including:
a threaded rod on the top of said gate; and
an adjustment knob having a threaded hole;
said threaded rod of said gate being inserted through said threaded hole of said adjustment knob;
whereby, when said adjustment knob being rotated in one direction said gate moving vertically upward, and when said adjustment knob being rotated in the other direction, said gate moving vertically downward.

9. The chlorinator of claim 8 wherein said threaded hole being made of a right side and a left side.

10. The chlorinator of claim 1 where said chlorinator section comprising a plurality of retaining pins being oriented in a circle adapted to retain a chlorine tablet in said chlorinator section;
said retaining pins including:
inlet retaining pins approximate to said inlet section; and
outlet retaining pins approximate to said outlet section;
said outlet retaining pins being spaced closer together than said inlet retaining pins.

11. The chlorinator of claim 9 wherein said chlorine tablet having a diameter of 1 inch.

12. The chlorinator of claim 1 where said housing having a bottom sloped in all directions toward said outlet, whereby, said chlorinator being self draining.

13. The chlorinator of claim 1 further comprising a top adapted to enclose said housing;
said top comprising a removable cap over said chlorinator section adapted for allowing chlorine tablets to be inserted into said chlorinator section;
said removable cap being a transparent cap adapted for allowing visual inspection of said chlorine tablet; and
said removable cap being threaded.

14. The chlorinator of claim 1 wherein said housing being a substantially rectangular shaped reservoir.

15. The chlorinator of claim 1 wherein said housing further comprising a chlorine indicator chart on the outside of said housing adapted for indicating the amount of chlorine present in the treated water.

16. The chlorinator of claim 1 adapted for adding % to 5 parts per million chlorine.

17. The chlorinator of claim 1 adapted for adding 1 to 2 parts per million chlorine.

18. A kit for treating water with a biosand filter and chlorinator comprising:
a biosand filter having an outlet; and
a chlorinator comprising:
a housing having an inlet on a side and an outlet on a bottom;
said inlet being adapted to be attached to the outlet of said biosand filter;
a dividing partition dividing said housing into an inlet section, an outlet section and a chlorinator section;
said inlet section being in communication with said inlet, said chlorinator section and said outlet section;
said chlorinator section being in communication with said inlet section and said outlet section;
said outlet section being in communication with said outlet; and
a flow control mechanism in said inlet section adapted to adjust the amount of water flowing through said chlorinator section.

19. The kit for treating water with a biosand filter having a chlorinator of claim 18 further comprising:
a plurality of chlorine indicator strips adapted for testing the amount of chlorine present in the treated water;
wherein said housing further comprising a chlorine indicator chart on the outside of said housing adapted for indicating the amount of chlorine present in the treated water.

20. A method of treating fluid by a biosand filter with a chlorinator comprising:
providing a biosand filter with an outlet;
providing a chlorinator comprising:
a housing having an inlet on a side and an outlet on a bottom;
said inlet being adapted to be attached to the outlet of a biosand filter;
a dividing partition dividing said housing into an inlet section, an outlet section and a chlorinator section;
said inlet section being in communication with said inlet, said chlorinator section and said outlet section;
said chlorinator section being in communication with said inlet section and said outlet section;
said outlet section being in communication with said outlet; and
a flow control mechanism in said inlet section adapted to adjust the amount of water flowing through said chlorinator section;
attaching the inlet of said chlorinator to the outlet of said biosand filter; and
treating fluid by moving the fluid through said biosand filter, out of said outlet, and into said chlorinator.
